(19) United States
(12) Patent Application Publication
(10) Pub. No.: US 2003/0196845 A1
(43) Pub. Date: Oct. 23, 2003

(54) Transverse power transmission system

(76) Inventors: William H. Briggs JR., Taylorville, IL (US); Eileen Elma Briggs, Taylorville, IL (US)

Correspondence Address: MICHAEL L. ANTOLINE, 2606 CHERRY HILLS DRIVE, CHAMPAIGN, IL, 61822, US

(21) Appl. No.: 10/126,763

(22) Filed: Apr. 19, 2002

(51) Int. Cl. B60K 17/00

(52) U.S. Cl. 180/337

(57) ABSTRACT

A power transmission shaft wherein power is transmitted to a transverse shaft by a shaft gearing means with the transverse shaft having a first power take off end and a second power take off end with a plurality of bearing supporting the shafts within either a conventional longitudinal internal combustion engine or a transversely mounted engine.

### CROSS REFERENCES TO RELATED APPLICATIONS

Not applicable.

### STATEMENT REGARDING FEDERALLY SPONSORED RESEARCH OR DEVELOPMENT

Not applicable.

### REFERENCED MICROFICHE APPENDIX

Not applicable.

### BACKGROUND

This invention relates to a power transmission system and more particularly to a system whereby an engine output shaft aligned transversely to a crankshaft is driven by an appropriate gearing mechanism. This allows power takeoffs to be located both in front and behind a transversely mounted engine or to each side of a longitudinally mounted engine. With a conventional longitudinally mounted engine, the engine, crankshaft, transmission and differentials are mounted in-line with the axis of the automobile. In conventional transverse engine configurations, the power is transmitted at one end of the crankshaft. The power drive train is then required to double back through a transmission, then into a differential whereupon the power is transmitted to the wheels. Power transmission from the transmission to dual differentials is seen in some present automobile configurations. Such engine/drive train configurations do not lend themselves to multiple engine outputs. In either existing configuration, power transmitted from one end of the crankshaft results in significant torsional loading and concomitant wear on engine components. Furthermore, the directional rotational momentum of the crankshaft and other internal engine components results in the engine pitching toward the direction of rotation.

It is, therefore, a principal object of this invention to provide an improved system for power transmission for the internal combustion engine or any engine, for example, generating rotational force on a shaft. It is a further object of this invention to provide power takeoffs through a shaft terminating both in front and behind the engine. It is a further object of this invention to transmit the power from the crankshaft to the transverse shaft at substantially the midpoint of the crankshaft thereby improving engine balance and reducing torsional engine pitch. It is a further object of this invention to reduce the torsional loading on the crankshaft and thereby reducing wear on engine components. It is a further object of this invention to reduce the gearage necessary to allow the doubling back of the engine drive train as seen in conventional transversely mounted engines. It is a further object of this invention to allow space saving engine/drive train configurations that will find application in many types of vehicles other than automobiles.

### SUMMARY

The present invention is directed to an apparatus adapted to be embodied in an internal combustion engine comprised of a plurality of combustion chambers or by any engine whereby power is generated and transmitted to a rotating engine output shaft or crankshaft. The crankshaft is supported by a pair of bearings located at the end of each crankshaft. The midpoint of the crankshaft is occupied by a gear, which can take the form of several configurations. The object of this gear would be to transmit the engine power to a geared shaft mounted in a transverse arrangement relative to the crankshaft. The shaft would exit the engine block. The points of exit would also be supported by bearings. This would result a first and second engine output. Either the first, second or both engine outputs could then, if applicable, enter a transmission and a differential thereby driving an axle.

The advantage of this system is that engines and drive trains may adopt a variety of positions and orientations allowing incorporation into a significant number of vehicle types. Further, the ability to adopt a variety of orientations could conserve space within vehicle types. These drive train configurations could be incorporated into automobiles, buses, boats, tanks and other armored vehicles or any type of vehicle that would benefit from the ability to flexibly orient a drive train.

### BRIEF DESCRIPTION OF SEVERAL VIEWS OF DRAWING

FIG. 1 is an side view of a transverse power takeoff or output shaft in relation to a crankshaft.

FIG. 2 is a elevation view of a transverse power takeoff exiting both side of an engine block.

FIG. 3 is a elevation view of a transverse power takeoff exiting one side of an engine block driving a set of front wheels.

FIG. 4 is a top view of a transverse power take off exiting one side of an engine block driving a set of rear wheels.

FIG. 5 is an elevation view of a transverse power take off exiting the side of an engine block that is set to one side of the vehicle.

FIG. 6 is a side view of an engine, transmission, gearbox in which the power is delivered to a point midway between the front and rear differential.

FIG. 7 is elevation view of an engine, transmission, gearbox in which the power is delivered to a point midway between the front and rear differential.

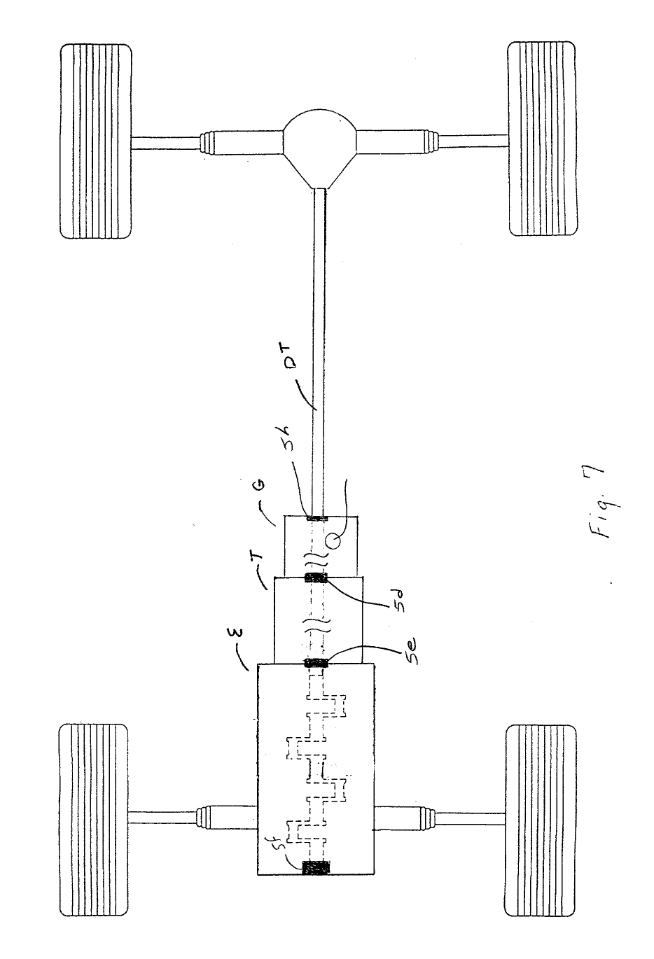

### DETAILED DESCRIPTION OF THE VARIOUS EMBODIMENTS

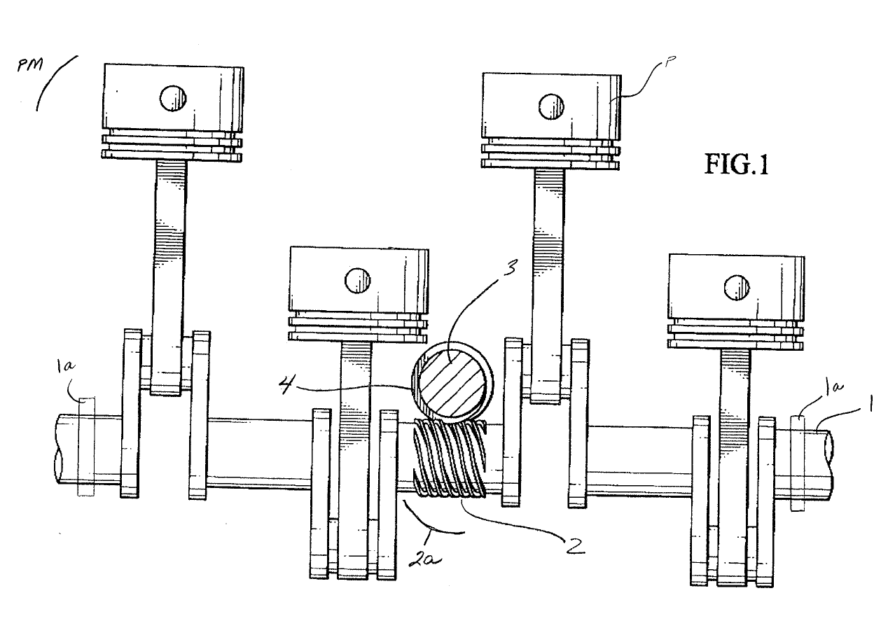

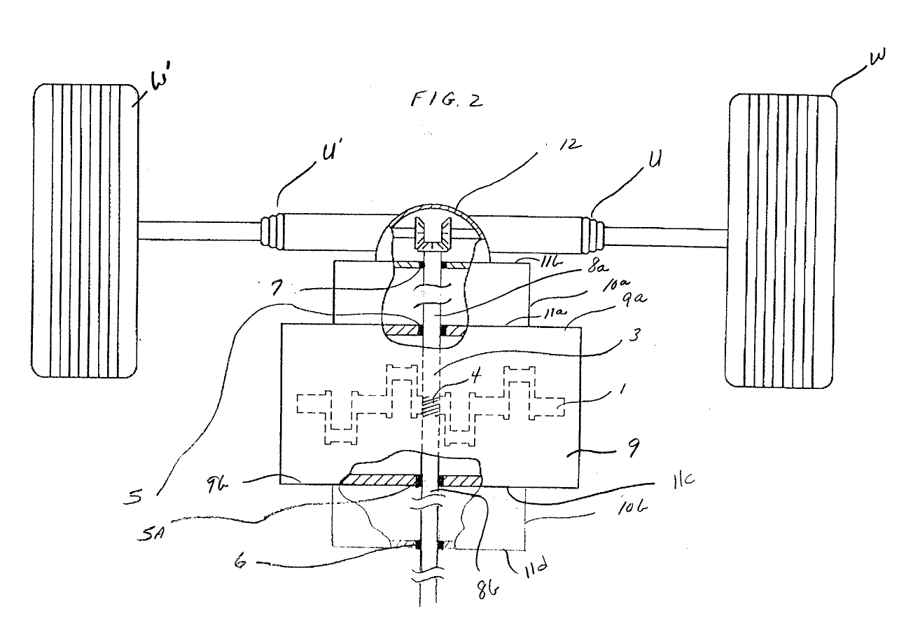

Referring first to FIG. 1, which illustrates power shaft 1 with a powering means PM here represented by a plurality of pistons P intended to operate within internal combustion chambers. At substantially the center of power shafts, is the shaft gearing means 2a, in this embodiment a worm gear. The transverse relationship between the powershaft 1 and the transverse shaft 3 is seen in the cross-section of transverse shaft 3. Transverse shaft 3 contains a gear, in this embodiment transverse shaft worm gear 4 is illustrated. Transverse shaft worm gear 4 intermeshes with powershaft worm gear 2 thus transmitting power between powershaft 1 and transverse shaft 3. Turning now to FIG. 2, powershaft 1 is also illustrated, this time within a transversely mounted engine block 9. Transverse shaft 3 is illustrated at right angles to the long axis of powershaft 1. Transverse shaft worm gear 4 of transverse shaft 3 is further illustrated. The transverse shaft 3 is supported by first bearing 5 and second bearing 5A at the points the transverse shaft 3 exists the engine block first wall 9a and engine block second wall 9b. This embodiment illustrates the first power take off end 8a of transverse shaft 3 entering first transmission 10a forward of the engine. Transverse shaft 3 is further supported by transmission wall bearing 7 in the wall of first transmission 10a opposite first bearing 5. The shaft is then acted on by the first transmission 10a, and the first power take offend 8a of transverse shaft 3 enters differential 12. The drive train is then split bifurcated exiting differential 12 and entering U-joints U and U′ then on to the wheels W and wheels W′. In this embodiment the second power take off end 8b of transverse shaft 3 also exits the engine rearward supported by second bearing 5A and is also acted on by second transmission 10b and continues, to a rear differential where the power is then transmitted to the wheels in a fashion similar to that seen forward of the transmission.

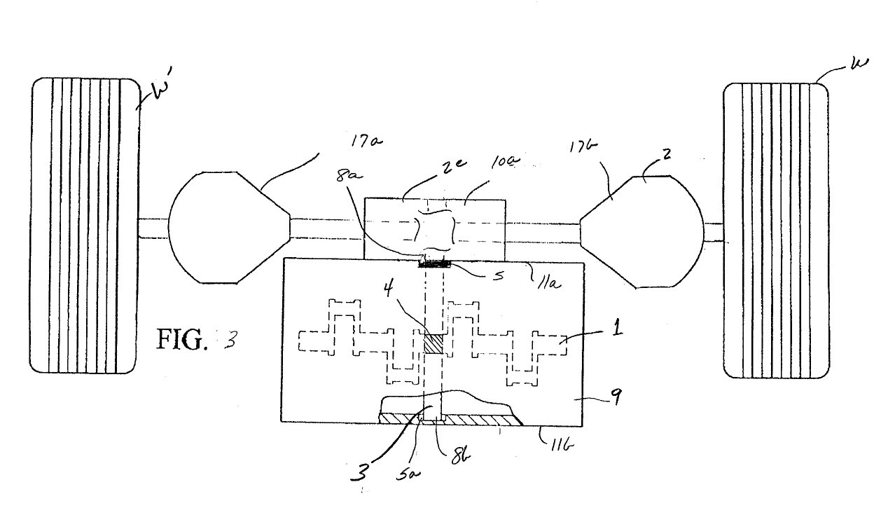

An alternate embodiment is illustrated in FIG. 3 where it is seen that transverse shaft 3 enters only first transmission 10a and the power train is then bifurcated with the power train then preceding to first laterally differential 17a and second lateral differential 17b and then on to the wheels W and W′.

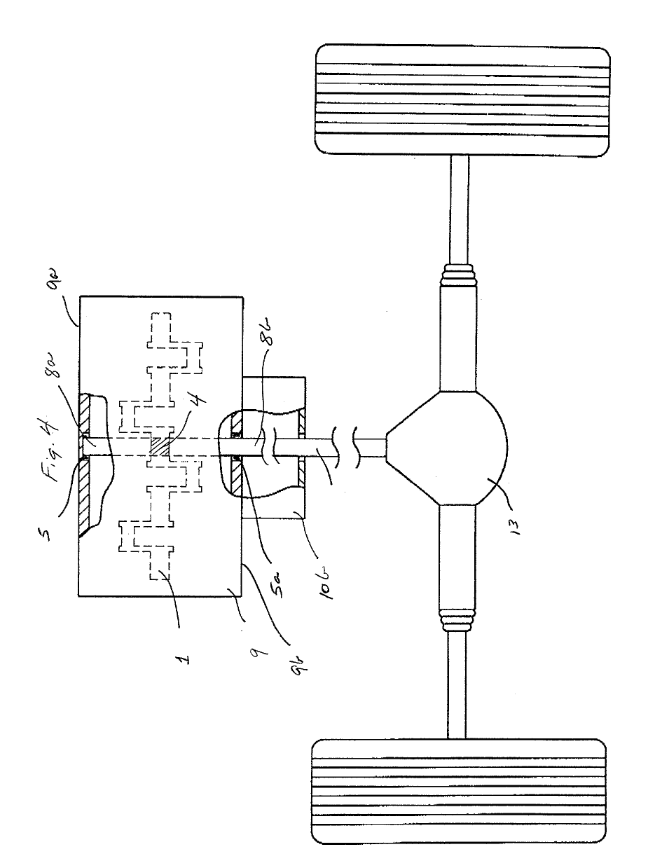

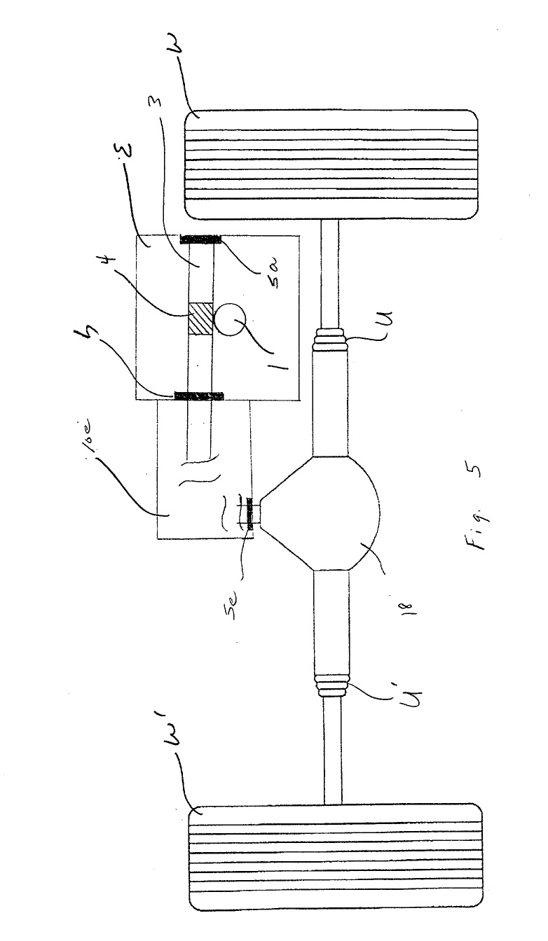

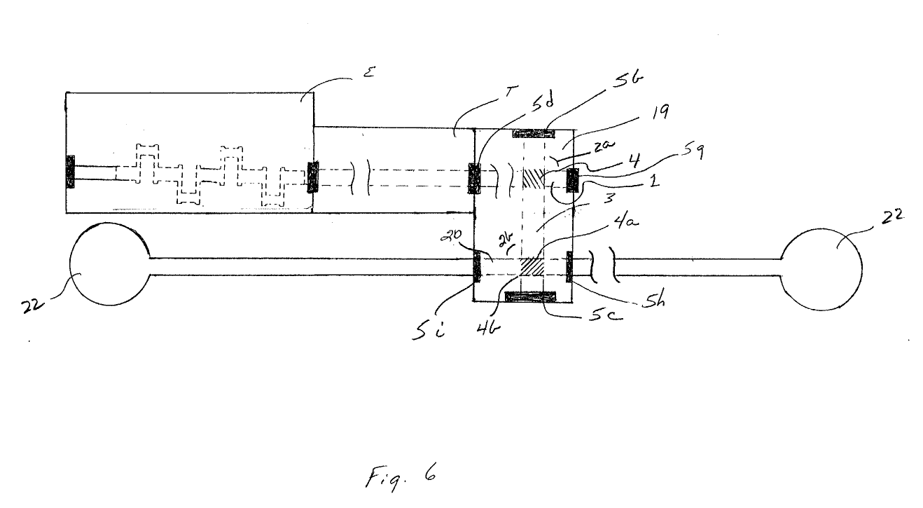

FIG. 4 illustrates an alternative embodiment of a power train orientation in which the transverse shaft 3 exits the rear of a front mounted engine, is acted upon by only second transmission 10b and then enters a rear differential 13. This configuration will find application in rear wheel drive vehicles. FIG. 5 illustrates the embodiment of an engine mounted to one side of the longitudinal centerline of a vehicle. The transverse shaft 3 then exits the engine supported by first bearing 5 and second bearing 5a. The shaft is acted upon by side mounted transmission 10e which altars the power train direction, in this case 90 degrees, exiting below the transmission 10e through bearing 5c. The power train then exits the side mounted transmission 10e, enters lower differential 18, then is bifurcated whereupon it enters U-joint U and U′ and to wheels W and W′. FIG. 6 illustrates a longitudinally oriented engine block E and transmission T with the transverse shaft 3 being contained within gearbox 19. Here transverse shaft 3 is supported within gear box 19 by first gear box bearing 5b and second gear box bearing 5c. As shaft gearing means 2a transfers power from the power shaft 7 to transverse shaft 3 through intermeshing transverse shaft worm gear 4 and power shaft worm gear 2. Here a second gearing means 2b is utilized to alter the power train 90 degrees using a second transverse shaft worm gear 4a entermeshing with a cross shaft worm gear 4b mounted on a cross shaft 20. The cross shaft then transmitts power to front differential 21 and rear differential 22.

What is claimed is:

1. A power transmission system comprising:
a power shaft,
a shaft gearing means mounted to said power shaft,
a transverse shaft having a first power take off end and a second power take off end, said transverse shaft rotatably communicating with said shaft gearing means, whereby power is transmitted from said power shaft to said transverse shaft,
a plurality of bearings supporting said power shaft and said transverse shaft,
a transversely mounted engine block in which said power shaft and said transverse shaft are rotatably mounted,
a first transmission, said first transmission receiving said a first power take off end,
a first differential, said first differential receiving said first power take off end from said first transmission, whereby power is then transmitted laterally thorough universal joints an on to a set of front wheels.
